(19) United States
(12) Patent Application Publication
(10) Pub. No.: US 2018/0176021 A1
(43) Pub. Date: Jun. 21, 2018

(54) IDENTITY VERIFICATION OF WIRELESS BEACONS BASED ON CHAIN-OF-TRUST

(71) Applicant: Andium Inc., New York, NY (US)

(72) Inventors: James Dooley, Colchester (GB); Jory Schwach, New York, NY (US)

(21) Appl. No.: 15/737,502

(22) PCT Filed: Jun. 20, 2016
(86) PCT No.: PCT/US2016/038417

§ 371 Date: Dec. 18, 2017

Related U.S. Application Data
(60) Provisional application No. 62/181,197, filed on Jun. 18, 2015.

(51) Int. Cl. H04L 9/32; H04W 12/06; H04L 29/06; G06F 21/44

(52) U.S. Cl. CPC H04L 9/3263; H04W 12/06; H04W 4/80; G06F 21/44; H04L 63/0823

(57) ABSTRACT

The methodology described herein provides a process of interaction between a Bluetooth beacon or other wireless beacon and a user-device. Embodiments of the method may allow the user-device to cryptographically verify the identity and provider of the beacon. Only if the user-device has a record of trust with the beacon provider may the beacon be considered trustworthy. The process may be automatic and may be convenient for the user who can then assess the trustworthiness of a beacon for further ad-hoc interaction without compromising the user-experience. This may be achieved without the need for a third-party, making it robust to situations where a user-device internet-connection is unavailable, unreliable or undesirable.

### CROSS-REFERENCE TO RELATED APPLICATIONS

This application claims the benefit of U.S. provisional application No. 62/181,197, filed 18 Jun. 2015, which is hereby incorporated by reference as though fully set forth herein.

### BACKGROUND

### a. Technical Field

The instant disclosure relates to the field of communications, and more particularly to method and systems by which a user-device can verify the identity and provider of a wireless beacon.

### b. Background Art

It is known that a Bluetooth device can be configured to transmit data for a separate device to receive. A transmitting device in this configuration is known as a beacon and the transmission scheme is known as a broadcast. It is commonly accepted that data broadcast by a beacon is inherently insecure, but convenient, and that it is therefore an acceptable methodology for assisting users discover nearby devices or services in ad-hoc networks.

One known type of beacon broadcasts a beacon specific UUID (as defined by ISO/IEC11578:1996 and IETF RFC4122). Any user-device, such as a mobile phone, that has a compatible Bluetooth receiver (hardware and software) can then use this UUID to trigger some action. Further interaction with the beacon is one possible course of action (for example using the Bluetooth Generic Attribute Profile: GATT), but most user-devices will use the acquired UUID to look up content online or trigger a device-specific action (such as send a text-message or post a message to social media).

Due to the open nature of a beacon broadcast, third parties can reprogram their own beacons to replicate a UUID (known as “spoofing” or “cloning”). Thus a user-device may make incorrect inferences about location and services, potentially resulting in falsely triggered actions. Furthermore, a third-party could trick a user-device into connecting to it by presenting a false UUID that the user-device believes to be safe. Other weaknesses will be apparent to those skilled in the art, such as the use of a Bluetooth “Friendly Name” that attempts to imply to a user that the beacon is safe (for example naming a malicious beacon by a hotel name and placing it in or near that hotel). For this reason, there is currently no way for a user-device (or user thereof) to be confident that a beacon broadcast is genuine or trustworthy.

Widespread adoption of the some known standards has been driven by service delivery (with wide uptake in the retail and advertising markets) that has been made simple by applications using a beacon UUID to interact with services online. This approach leverages existing web technologies, mitigates the technical limitations of Bluetooth (such as low bandwidth) and defers security and privacy concerns of users to online services, which are far better understood. The problem of spoofed/cloned beacons is not solved by this approach, but the potential for exploitation is mitigated by the user-device interacting with online services which are not spoofed/cloned. But this approach does require that the user-device has a reliable internet connection through some network (such as WiFi or cellular).

The foregoing discussion is intended only to illustrate the present field and should not be taken as a disavowal of claim scope.

### BRIEF SUMMARY

To overcome the problems of prior art beacon-based communications, a method by which a user-device can automatically verify the identity and provider of a wireless beacon is provided in this disclosure. Advantageously, methods consistent with the present disclosure need not rely on the availability of a third-party service to assist in the verification process at the time of interaction between user-device and beacon (i.e. the only interactions that a user-device makes at time of beacon discovery is with the beacon itself, in an embodiment).

The instant disclosure includes a method for identity verification of wireless beacons, such as Bluetooth beacons, for example only. In an embodiment, the method may take advantage of the underlying principle of a Bluetooth or other wireless beacon being able to cryptographically prove that it has been supplied by a provider that the user-device trusts. Thus a transient property of trust can exist between the beacon itself and the user-device without either entity having any prior knowledge of the other. Furthermore, the user-device may not need to defer judgment to a human user or contact any other service in order to achieve this trust. Thus, a one-way trust relationship may exist, as users may intentionally be anonymous to beacons in order to preserve user privacy. In an embodiment, the method may be include a three-step algorithm that is capable of verifying the identity of a wireless beacon given certain conditions.

The advantages of the instant disclosure are numerous, as would be apparent to those of ordinary skill in the art. For example, methods and systems consistent with this disclosure may be mutually beneficial to both a service provider and an end-user; the provider may be able to guarantee the authenticity of its beacons and services, while simultaneously denying malicious actors from making use of the provider identity or associated reputation. In an embodiment, automatic operation of the method may be both convenient and beneficial to the end-user, who may be empowered with the confidence to know which wireless beacons are trustworthy. Further, in an embodiment, the method may provide the user with anonymity to the beacon, thereby preserving user privacy. Further, methods consistent with this disclosure may enable authentication without requiring the user-device to have an active internet connection at the time of interaction with a beacon. This enables the beacon to be reliably used in situations where an internet connection is unavailable, unreliable or undesirable.

### BRIEF DESCRIPTION OF THE DRAWINGS

FIG. 1 depicts an exemplary user-device and an exemplary beacon whereby the user-device may discover the beacon.

FIG. 2 depicts exemplary events which may enable a user-device to discover a beacon.

FIG. 3 depicts an exemplary embodiment of a three-stage process by which a user-device may verify the identity of a wireless beacon.

### DETAILED DESCRIPTION

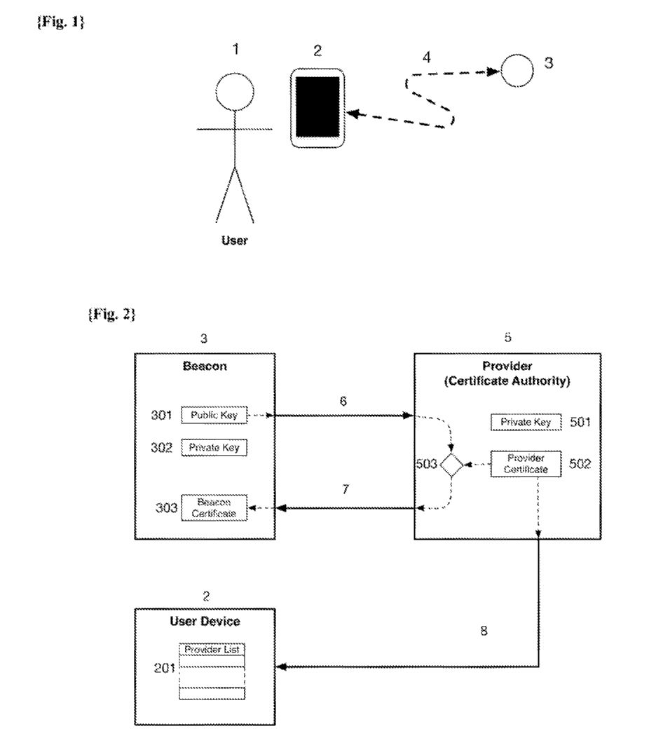

Referring to the drawings, wherein like reference numerals indicate the same or similar features in the various views, FIG. 1 illustrates a system in which a user-device may communicate with a wireless beacon. As depicted in FIG. 1, a user 1 may be associated with a user-device 2 (such as laptop, mobile phone, tablet, wearable, etc.). When the user-device 2 is close enough to the beacon 3, it will receive an advertisement message that is broadcast by the beacon 3 using a wireless communication protocol 4. This may or may not be the first time these two particular devices have been in contact, and so there may be no assumed prior knowledge of either device, in an embodiment.

The wireless protocol 4 may be, for example, Bluetooth, Bluetooth Low Energy (BLE), IEEE 802.11 (WLAN), IEEE 802.15 (WPAN), IEEE 802.16 (WiMAX), IEEE 802.15.4 (ZigBee), a 45 MHZ spectrum band, a 900 MHz spectrum band, LTE, ISM Band, other protocols in the 433-900 MHZ spectrum, or any other appropriate wireless communication protocol. For the remainder of this disclosure, embodiments utilizing Bluetooth communications will be described. It should be understood, however, that this is for ease of discussion only and the instant disclosure is not limited to Bluetooth embodiments.

FIG. 2 illustrates two conditions that may enable contact between the user-device 2 and the beacon 3 over the wireless communication protocol 4 as described above with reference to FIG. 1. Referring to FIG. 2, the order in which these two pre-conditions occur may be irrelevant, in an embodiment. A first pre-condition may be the creation of a digital certificate chain 303 for the beacon 3. This may be achieved by the beacon 3 supplying its beaconID and public-key 301 to the Certificate Authority 5 (which may alternatively be referred to as a “Provider”). This could be achieved directly 6, or by some indirect method involving another entity (for example, a registration device, online management system, etc.). The Provider 5 may then create a digital certificate consisting of the beaconID, beacon public-key 301, provider-certificate 502 and any other pertinent information to be included (for example times of validity, cipher algorithm used and key-size). The certificate may then be signed 503 by the Provider using its private-key 501 (where the public-key held in the provider certificate 502 and private-key 501 form a key-pair). The newly created beacon certificate is then sent 7, directly or indirectly, back to the beacon where it is stored 303.

In the exemplary embodiment illustrated in FIG. 2, the user-device 2 may maintain a provider-list 201 in which the user-device 2 may store a record of known (and trusted) provider certificates. Independent of the first pre-condition, the second pre-condition may include the storage of the provider certificate 502 in the user-device 2 provider-list 201. This means that the provider-certificate 502 may have been communicated 8 (directly, or indirectly by some other mechanism) to the user-device 2 and stored in the provider-list 201.

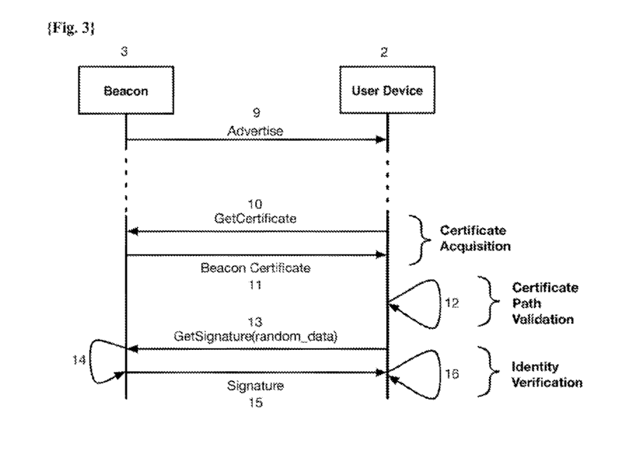

With the two pre-conditions depicted in FIG. 2 completed, in an embodiment, a user-device 2 and a beacon 3 may make contact as depicted in FIG. 1. FIG. 3 depicts an exemplary three-step algorithm that may enable allow the user-device to cryptographically verify the identity and provider of the beacon. The user-device 2 first becomes aware of the beacon 3 proximity by receipt of at least one broadcast advertisement message 9 (these messages are broadcast periodically). When the user-device 2 is ready to verify the identity of the beacon 3 (this may be a pro-active decision or one prompted by a user), it may carry out the three-step algorithm below, in an embodiment.

Step-one: Certificate-Acquisition: whereby the beacon certificate 303 is provided to the user-device 2. This may be achieved by the user-device 2 issuing a GetCertificate request 10 to the beacon 3. The beacon 3 may immediately respond 11 by sending the beacon certificate 303. If the user-device 2 does not successfully receive the beacon certificate 303 within a specified time period, the step may fails due to a timeout.

Step-two: Certificate-Path-Validation: whereby the beacon certificate is cryptographically validated 12 and may or must include an entity that the user-device 2 trusts (i.e. there is a provider certificate in the beacon certificate chain that also exists in the provider-list 201 of the user-device 2). This process may establish trust between user-device 2 and beacon certificate 303 (as a transient property of the trust between user-device 2 and provider 5 that arises from the proven trust between provider 5 and beacon-certificate 303). If the beacon certificate 303 fails validation 12, or does not contain an entity that is also on the provider-list 201 held by the user-device 2, then the step may fail due to an invalid or untrusted beacon certificate.

Step-three: Identity-Verification: whereby the beacon 3 is challenged to cryptographically prove that it is the legitimate owner of the beacon certificate 303, thereby establishing trust between the user-device 2 and beacon 3 (as a transient property of the trust between user-device 2 and beacon-certificate 303 that was established in step-2). This may be achieved by the user-device 2 issuing a GetSignature request 13 to the beacon 3. The request 13 may include a payload of randomly generated data for the beacon 3 to immediately sign 14 using its private-key 302. The signature may then be immediately returned 15 to the user-device 2, where it can be verified 16 using the beacon public-key 301 that is held in the beacon certificate 303 by the user-device as a result of step-1 and step-2. If the user-device 2 does not successfully receive the requested signature within a specified time period, the step may fail due to timeout. If the verification 16 of the returned signature fails, then the step may fail due to invalid signature.

Success of these three steps implies that the beacon is furnished by a trustworthy provider 5, giving the user 1 confidence that future communications are safe. The user-device 2 may automatically to carry out these steps with no dependence on user-interaction, thus this methodology may address the security concerns of using a beacon 3 while maintaining a convenient user-experience.

Implementations of this algorithm are free to choose a timeout value that is sensible to the application and environment.

Providers 5 are free to choose an appropriate cipher algorithm and key-size for the application (and record it as part of the provider certificate 502). User-devices 2 are free to only accept certain cipher algorithms and key-sizes as part of step-2 (certificate-path-validation). If a cipher algorithm or key-size is used that the user-device 2 does not accept, then step-2 should fail due to inappropriate cipher algorithm or key-size.

User-devices 2 may choose to only add a provider-certificate 502 to its provider-list 201 if it uses an acceptable cipher algorithm and key-size. If a cipher algorithm or key-size is used that the user-device 2 does not accept, the provider-certificate 502 should not be added to the provider-list 201.

An implementation of this algorithm may choose to offer slightly modified functionality to the way in which step-2 failure is handled. In the case where no member of the beacon-certificate chain 303 is present in the user-device 2 provider-list 201, an implementation may choose to revert to asking the user 1 if the beacon 3 should be trusted. Alternatively, the user 1 could also be asked if one of the providers 5 from the beacon certificate 303 should be added to the user-device 2 provider list 201.

In embodiments, it may be essential that the interpretation of a Provider 5 is correct and is as close in a chain of ownership to the beacon 3 itself as possible. For example, it may be inadvisable to consider the equipment manufacturer of a given device as the trusted “Provider” 5, as a user-device 2 would then trust any beacon 3 of that brand, regardless of who has bought and modified it, for example. Thus, the provider may be identified according to the owner of the beacon, as the owner may provide a guarantee or otherwise heightened degree of legitimacy. This could be an individual person (for example, where a beacon is stored in a private residence) or a legal entity such as a retail company (where the beacons are installed in the retail outlets of that company).

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system for communication of compatible wireless devices, the system comprising:
at least one Provider that has a private-key and signed digital certificate containing the public-key;
a wireless beacon device that broadcasts its identity at periodic intervals, the device having been configured with a beaconID, private-key, public-key and a digital certificate containing those configuration items in addition to other configuration items, where the certificate is digitally signed by the private-key of the beacon provider; and
at least one wireless user-device that is capable of receiving the broadcasts of the wireless beacon, the user-device having been configured with a list of digital certificates that reflect providers trusted by that user-device.

2. The system of claim 1, wherein the user-device can perform certificate-acquisition by requesting that the beacon wirelessly send its signed certificate to the user-device.

3. The system of claim 2, wherein the user-device is configured to perform certificate-path-validation of the beacon-certificate that has been acquired wirelessly by matching a provider that has signed the beacon-certificate (as a root or intermediate) against a provider in the provider-list held by the user-device and cryptographically validating the beacon certificate using the public-key of that matching provider-certificate in the provider-list held by the user-device.

4. The system of claim 3, wherein the user-device is configured to begin identity-verification by acquiring a digital signature from the beacon for a randomly generated data set by the user-device sending a GetSignature request to the beacon which includes a set of random data, the beacon calculating a signature for that data using its private-key, and the user-device successfully receiving the signature back.

5. The system of claim 4, wherein the user-device is configured to cryptographically verify the identity and provider of the beacon by using the public-key held by the user-device in the beacon-certificate to verify the data signature returned by the beacon and determining if the signature is valid.

6. The system of claim 1, wherein the wireless beacon device broadcasts using Bluetooth.

7. The system of claim 1, wherein the wireless beacon device broadcasts using Bluetooth Low Energy.

8. The system of claim 1, wherein the wireless beacon device broadcasts using WLAN.

9. The system of claim 1, wherein the wireless beacon device broadcasts using WPAN.

10. The system of claim 1, wherein the wireless beacon device broadcasts using WiMAX.

11. The system of claim 1, wherein the wireless beacon device broadcasts using ZigBee.

12. The system of claim 1, wherein the wireless beacon device broadcasts using LTE.

13. The system of claim 1, wherein the wireless beacon device broadcasts using an ISM Band.

14. The system of claim 1, wherein the wireless beacon device broadcasts using a protocol in the 433-900 MHZ spectrum.

15. The system of claim 1, wherein the wireless beacon device broadcasts using a 900 MHz spectrum band.
